(19) United States
(12) Patent Application Publication
(10) Pub. No.: US 2023/0222288 A1
(43) Pub. Date: Jul. 13, 2023

(54) SMART TEXT PARTITIONING FOR DETECTING SENSITIVE INFORMATION

(71) Applicant: Capital One Services, LLC, McLean, VA (US)

(72) Inventors: Rui ZHANG, New York, NY (US); Sudheendra Kumar KAANUGOVI, Aldie, VA (US); Sandeep K. GADDE, Ashburn, VA (US)

(73) Assignee: Capital One Services, LLC, McLean, VA (US)

(21) Appl. No.: 17/571,761

(22) Filed: Jan. 10, 2022

(51) Int. Cl. G06F 40/205; G06F 40/284

(52) U.S. Cl. CPC G06F 40/205; G06F 40/284

(57) ABSTRACT

Systems for partitioning text are disclosed. The system can receive a text string. A delimiter can be identified based on the text string. Based on identifying the delimiter, a character sequence to the left and/or right of the delimiter can be identified. The identification can occur up to a predetermined number/length of characters. Using a trained model, the system can determine whether the character sequence indicates the delimiter is part of a continuous string of text. Based on determining whether or not the delimiter is part of the continuous string of text, the system can generate a token representing the continuous string of text or the delimiter.

### TECHNICAL FIELD

Aspects relate to systems and methods for text partitioning using machine learning models.

### BACKGROUND

Sensitive data, for example personal identifying information (PII), passwords, account numbers, social security numbers, etc., is provided to companies regularly. Sensitive data generally refers to data that should not be disclosed to the public and its distribution should be protected using data protection and security measures. This type of data can take various forms and often contains delimiters such as periods (“.”), dashes (“-”), semicolons (“;”), underscores (“_”), commas (“,”), etc. The source of this data may be varied, and can include clients, employees, third-party services, etc. The data can also be embedded in text strings input into the systems of the company via web interfaces, or can be part of documents received or generated by the company. Various laws and regulations, for example the General Data Protection Regulation (GDPR) of the European Union, and the California Consumer Privacy Act (CCPA) of the State of California in the USA, require companies to implement systems to secure such sensitive data. Thus, it is vitally important for companies to secure this data.

Companies often used natural language processing (NLP) techniques throughout their systems to automate text-based processes, such as detecting information, classifying information, detecting sensitive data in files on their servers or network, etc. The ability to partition text is fundamental to NLP and consequently to detecting sensitive data. Two common types of partitioning are tokenization and sentence splitting. Tokenization is the process of breaking a stream of text up into words, phrases, symbols, or other meaningful elements called tokens. Sentence splitting is the process of dividing text into sentences.

Both important text partitioning tasks above also rely on delimiters such as white spaces, periods, dashes, semicolons, underscores, commas, etc. to determine when one word ends and one word begins. However, sometimes sensitive data also contains these types of delimiters, as indicated above. For example, in the financial context, information such as a credit card number (as an artificial example “1111-2222-3333-4444”) or a date (e.g., “01.01.1900” or “01-01-1900”) can be delimited but represent a single continuous string of text. Conventional text partitioning systems are deficient because they often break up this delimited text, not recognizing that the text string should actually be a single continuous string of text. For instance, the card number above might be treated as 7 tokens: 1111, 2222, 3333, 4444 and three dashes. The date above might be split across two sentences due to the use of periods. This renders it unnecessarily difficult, if not impossible, to identify these types of data in subsequent NLP steps, such as classifications that can be performed by a named entity recognition (NER) component or specially trained classifiers for sensitive information detection. Thus, systems and methods are needed to address the aforementioned problem to recognize delimiters that could be part of sensitive data.

### SUMMARY

Aspects disclosed herein provide systems and methods for partitioning text. The systems and methods improve conventional systems by providing a way for computers to recognize sensitive data even when it contains delimiters. This way, text strings containing delimiters can be recognized as a single contiguous string and not be split into different tokens. Thus, the system disclosed improves the functioning of computers by allowing computers to more accurately recognize words in text strings.

In aspects, the system performs its function by first receiving a text string. The system can identify a delimiter based on the text string. Based on identifying the delimiter, the system can identify, to a predetermined length of characters, a character sequence to the left or right of the delimiter. Using a trained model, the system can determine whether the character sequence indicates the delimiter is part of a continuous string of text. A first token representing the continuous string of text can be generated if the delimiter is determined to be part of the continuous string of text. A second token can be generated representing the delimiter if the delimiter is determined to not be part of the continuous string of text.

In aspects, the system can receive the text string in real-time based on inputs entered into a client device. In aspects, the system can receive the text string as part of a document that is received. The text string can be embedded in the document. In aspects, the trained model can be a character-level sequence-to-sequence model. Such models can be, for example, long-short term memory (LSTM) models, Recurrent Neural Network (RNN) models, or similar models. In aspects, the delimiters can include a dash, a period, a semicolon, an underscore, a comma, or a period.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is a system for partitioning text according to aspects of the present disclosure.

FIG. 2 is an example method of operating the system to identify a delimiter and generate a token based on identifying a character sequence to the left or right of the delimiter according to aspects of the present disclosure.

FIG. 3 is an example architecture of devices that can be used to implement the system according to aspects of the present disclosure.

In the drawings, like reference numbers generally indicate identical or similar elements. Additionally, generally, the leftmost digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

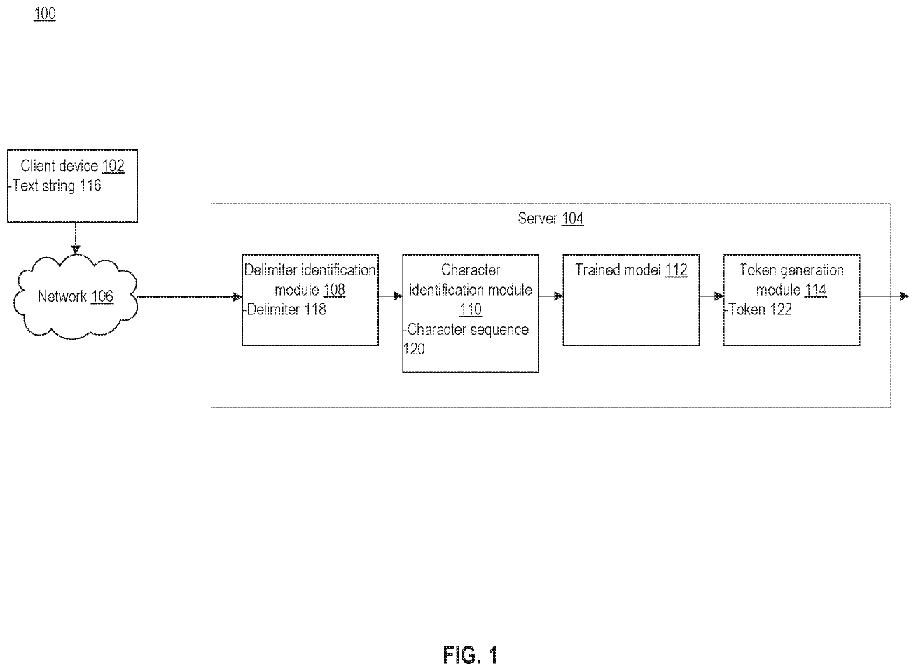

FIG. 1 is a system 100 for partitioning text according to aspects of the present disclosure. System 100 can implement a binary classifier. A binary classifier refers to a hardware and/or software executing that classifies elements of a set into two groups on the basis of classification rules. In aspects, the system 100 can classify delimiters in text strings it receives. Delimiters can be classified based on whether they are part of a single word, or they delimit between two separate words. Being able to perform this type of classification is useful when attempting to recognize certain types of data such as social security numbers, dates, credit card numbers, account numbers, passwords, etc. that often have delimiters as a part of a numeric or alpha-numeric string of text. Often, data in this form also represents sensitive data. Examples of sensitive data with delimiters can include social security numbers, credit card numbers, account numbers, passwords, etc., or PII, which can be used to identify an individual, and can be birthdays, addresses, etc. This sensitive data needs to be recognized so it can be properly handled and protected by company systems.

Because more companies are beginning to automate their text processing functions using automated systems implementing NLP techniques (e.g., automated call centers, automated financial transaction systems, Chatbot based applications, knowledge retrieval systems, etc.), these systems need a way of recognizing sensitive data input or processed to protect that sensitive data due to various contractual, ethical, or legal/regulatory requirements. Thus, system 100 can be used with, and/or integrated with, automated systems implementing NLP techniques to better identify and recognize sensitive data.

In aspects, the system 100 may be implemented on server 104. The server 104 may be a variety of centralized or decentralized computing devices. For example, the server 104 may be a mobile device, a laptop computer, a desktop computer, grid-computing resources, a virtualized computing resource, cloud computing resources, peer-to-peer distributed computing devices, a server farm, or a combination thereof. The server 104 may be centralized in a single room, distributed across different rooms, distributed across different geographic locations, or embedded within a network 106. The server 104 can couple with the network 106 to communicate with other devices, such as a client device 102. The client device 102 may be any of a variety of devices, such as a smartphone, a cellular phone, a personal digital assistant, a tablet computer, a notebook computer, a laptop computer, a desktop computer, a further server, or a combination thereof. The server 104 and the client device 102 may be stand-alone devices and work independently from one another.

The network 106 refers to a telecommunications network, such as a wired or wireless network. The network 106 can span and represent a variety of networks and network topologies. For example, the network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 can traverse a number of topologies and distances. For example, the network 106 can include a direct connection, personal area network (PAN), local area network (LAN), metropolitan area network (MAN), wide area network (WAN), or a combination thereof.

In aspects, system 100 can function by first receiving a text string 116. The text string 116 can be received either directly from inputs entered into the client device 102 or can be part of a document received by the server 104, where the text string 116 is embedded in the document. By way of example, if the text string 116 is received directly from inputs entered into a client device 102, it can be received via a mobile application, a graphical user interface (GUI), a web application, a desktop application, where text is input into a box or field and transmitted to the server 104. If the text string 116 is received via a document, the document can be any text based computer file such as a text file, a MICROSOFT WORD™ file, a JavaScript Object Notation (JSON) formatted text file, etc. In aspects, the text string 116 can be transmitted to the server 104 in real-time. For example, the text string 116 can be transmitted to the server 104 as it is being input into the client device 102. By way of example, if a user is inputting text into a box or field of a mobile application, a graphical user interface (GUI), a web application, a desktop software application, etc., the text can be transmitted to the server 104 in real-time as it is being typed or after every keystroke. Real-time refers to the text being transmitted to the server 104 within seconds or milliseconds after it is typed into a box or field. The text string 116 can be transmitted to the server 104 via the network 106.

In aspects, the text string 116 can be received by a delimiter identification module 108. The delimiter identification module 108 can enable identification of a delimiter 118 in the text string 116. In aspects, the delimiter identification module 108 can identify the delimiter 118 by parsing the text string 116 and performing a keyword match. Thus, when a delimiter 118 is encountered and matched to a known delimiter type (e.g., a dash, a semicolon, an underscore, a comma, a period, etc.), the system 100 can determine that a delimiter 118 has been encountered, and the system 100 needs to determine whether the delimiter 118 is part of a continuous string of text or whether it is a stand-alone character that separates two words in the text string 116.

In aspects, once the delimiter 118 is identified, control and the text string 116 can be passed to a character identification module 110. The character identification module 110 enables identifying a character sequence 120 to the left and/or to the right of the delimiter 118. In aspects, the character identification module 110 can identify the character sequence 120 by beginning at the character location of the delimiter 118 and identifying each character to the left and/or right of the delimiter 118. In aspects, and in order to limit how many characters are identified, the character identification module 110 can identify the character sequence 120 to the left and/or right of the delimiter 118 up to a predetermined length of characters. For example, the predetermined length of characters can be five (5), ten (10), etc. characters. The value for the predetermined length of characters can be determined and modified by an administrator or designer of the system 100, or by hyper-parameter tuning algorithms known to a person of skill in the art (POSA). The purpose of identifying the character sequence 120 to the right and/or left of the delimiter 118 is to use that character sequence 120 to identify what type of word, numerical value, type of data, etc. precedes or follows the delimiter 118, or what word, numerical value, type of data the delimiter 118 may be a part of How the system 100 identifies what type of word or numerical value precedes or follows the delimiter 118 will be discussed further below.

In aspects, once the character sequence 120 is identified, control, the character sequence 120, and the delimiter 118 can be passed to a trained model 112. The trained model 112 enables determining whether the character sequence 120 and the delimiter 118 are part of a continuous string of text or not. In aspects, the trained model 112 can be implemented as a character-level sequence-to-sequence model. Sequence-to-sequence models are known to a POSA. Such models can be implemented with LSTMs, RNNs, any similar machine learning models, or a combination thereof. The trained model 112 can function with inputs being the individual characters of the character sequence 120 and the delimiter 118, thus working at a character-level.

In aspects, the trained model 112 can be trained to recognize particular sequences or patterns of text. For example, the trained model 112 can be trained to recognize various types of words, numerical values, forms that data can take, etc. that contain various delimiters 118. For example, the trained model 112 can be trained to recognize formats for social security numbers, credit card numbers, dates, passwords, account numbers, etc. that may have delimiters 118 within the string of text. This training can be done using a corpus of text with examples of various formats for social security numbers, credit card numbers, dates, passwords, account numbers, etc. and variations of those data, in addition to formats of text and numbers not including social security numbers, credit card numbers, dates, passwords, account numbers, etc. Labels can then be provided for specific data indicating that a delimiter should be part of a continuous string of text, and iteratively, the trained model 112 can be taught to recognize the patterns using these labels. The training can also include fine-tuning the parameters of the trained model 112 through a back propagation process so that the trained model 112 and its weights, biases, etc. can be optimized to recognize the patterns. A POSA will recognize how to optimize the trained model 112 using a back propagation process given this disclosure.

By way of example, the trained model 112 can be trained to recognize that a social security number is in the form “XXX-XX-XXXX,” where “X” is a number. Thus, if the delimiter 118 “-” is preceded or followed by a numerical sequence “XXX” or “XX” or “XX-XXXX,” the trained model 112 can be trained to recognize that pattern, and determine that the delimiter 118 is part of a continuous string of text that is likely to be a social security number. In aspects, the trained model 112 does not have to completely recognize the social security number and can partially recognize the social security number, recognizing, based on part of the continuous string of text, that the continuous string of text could be a social security number. In this way, the trained model 112 can be less stringent in pattern recognition. This principle can be applied to other types of sensitive data and not just social security numbers. For example, partial recognition of dates, passwords, credit card numbers, account numbers, etc. can also be performed when the system 100 works to recognize these types of sensitive data.

In aspects, the trained model 112 be trained or work in conjunction with rules to favor minimizing false negatives over minimizing false positives when recognizing whether the delimiter is part of a continuous string of text, under the assumption that downstream NER components will limit the impact of the false positives. The trade-offs between false negatives and false positives can be made in conjunction with the downstream NER components by hyper-parameter tuning algorithms known to a POSA. More about the NER components will be discussed further below.

In another example, the trained model 112 can be trained to recognize that a date can be written in the form “XX.XX.XXXX,” where “X” is a number. Thus, if the delimiter “.” is preceded or followed by a numerical sequence “XX” or “XX.XXXX,” the trained model 112 can be trained to recognize that pattern and determine that the delimiter 118 is part of a continuous string of text that is likely to be a date. The same technique can be used if the “.” is replaced by a “-”.

The trained model 112 can also be trained to recognize that particular numbers are more indicative of dates. For example, because the Gregorian calendar has twelve months in a year, and each month is represented by a number one (1) through twelve (12), and each month is typically thirty (30) or thirty-one (31) days, if the particular sequence “XX.XX.XXXX,” has numbers corresponding within the range of numbers typically found in months and days, the trained model 112 can determine that the delimiter 118 is likely to be part of a date. Additionally, if the sequence has a four-digit number likely indicating a year for the value of “XXXX” (e.g., 19XX, 20XX, etc.), the trained model 112 can be trained to recognize that the numerical sequence likely indicates a year when taken in conjunction with the numbers indicating months and days, and can further be indicative of a date.

Similarly, the trained model 112 can be trained to recognize monetary values that take the form “[MONEY SYMBOL]X,XXX” or a variation thereof, where “X” is a number. For example, if the delimiter “,” is encountered and is preceded by a number and a symbol for money (e.g., “$,” “€”, etc.), the trained model 112 can be trained to recognize that the delimiter is part of a continuous text string indicating a monetary value. Additionally, if the monetary value takes the form “[MONEY SYMBOL] X, XXX” or a variation thereof, the white spaces can also be accounted for, and the trained model 112 can recognize that the white spaces do not delineate between different words but rather all the characters belong to the same character string representing a monetary value.

The trained model 112 can also be trained to recognize certain words containing delimiters. For example, the trained model 112 can be trained to recognize hyphenated words such as “two-fold,” “check-in,” “father-in-law,” etc. so that when character sequences are encountered where the characters in the character sequence 120 match these words, the trained model 112 will know that it is likely that the dash is part of a continuous string of text. This can be done by having the trained model 112 recognize that all the characters of the character sequence 120 are letters and try to match those letters to words of a database or repository serving as a dictionary. If a word match is found, the trained model 112 can then determine if the word is typically a hyphenated word based on its training to recognize such words.

While the aforementioned are indicated as examples of the types of data that the trained model 112 can be trained to recognize, these are merely examples. The trained model 112 can be trained to recognize other forms of data that have fixed patterns and that can contain delimiters. These can include account numbers, passcodes, identification numbers, etc.

In aspects, the output of the trained model 112 can be a probability or classification indicating that the delimiter 118 and the character sequence 120 should be considered as part of a continuous string of text. In aspects, once the trained model 112 generates its output, control and the text string 116, the delimiter 118, and the character sequence 120 can be passed to a token generation module 114. The token generation module 114 can enable generating a token 122 based on the output of the trained model 112. A token refers to a fundamental character, word, or numerical unit for NLP.

By way of example, if the trained model 112 generates an output indicating that the character sequence 120 and the delimiter 118 are likely part of a continuous string of text, the token generation module 114 can generate a token 122 representing the continuous string of text that the trained model 112 believes the character sequence 120 and the delimiter 118 represent. This can be done by, for example, copying the character sequences to the right and left of the delimiter 118 and the delimiter 118 itself, and appending the same into one continuous unit, to form the continuous string of text. Taking the example of a date represented as “XX.XX.XXXX,” the token generation module 114 can copy the characters to the left and right of either “.” to form a date pattern, so that the entire continuous string of text encompasses all the values for “X” and the delimiter 118. The copying can be done so that all the characters copied form the pattern expected for that type of data. In this way, rather than splitting up the values for “X” due to the delimiter 118, the values can be formed into one continuous string to properly represent the values as a date. Similar methods can be used for other patterns the trained model 112 is taught to recognize. In aspects, if the trained model 112 generates an output indicating that the character sequence 120 and the delimiter 118 are not likely part of a continuous string of text, the token generation module 114 can generate a token 122 representing the delimiter 118 itself and treat the words or characters to the right and/or left of the delimiter 118 as part of different words or values. In this way, tokens can be generated for various words in the text string 116.

In aspects, the token 122 can be sent to further downstream components or modules to be classified. This classification can be performed by a named entity recognition (NER) component. NER components are known to a POSA and any number of known techniques implementing NER functionality can be used to perform the classification. In aspects, this classification can label the token 122 as a particular type of data. For example, based on the sequence or pattern of the token 122 the token can be labeled as a social security number, a date, an account number, etc.

In aspects, if the output is determined to be a continuous string of text representing sensitive data the system 100 can pass the continuous string of text to further modules to protect the sensitive data. This can be done by having the further modules mask or encrypt the continuous string of text. The masking can, for example, replace certain characters of the with special characters such as “*” to hide the value of the character. Alternatively, the string of text can be encrypted using any encryption algorithm known to a POSA to hide the continuous string of text so that it cannot be deciphered without performing a decryption process on the string of text.

The modules described in FIG. 1 may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 or installed as a removable portion of the system 100.

It has been discovered that the system 100 described above improves the state of the art from conventional systems because it provides a novel way for computers to partition text strings that contain delimiters. Thus, text strings containing delimiters can be recognized as a single contiguous string and not be split into different tokens by systems performing NLP. As a result, the system 100 improves the way NLP is performed because it allows computers to more accurately recognize individual words in text strings.

System 100 can be used in a variety of areas implementing NLP techniques. These include financial applications, security applications, etc. where certain classes of data need to be recognized and protected. For example, when processing financial data certain categories of data can be classified as sensitive, such as social security numbers, credit card numbers, account numbers, etc. These often have delimiters as a part of a numeric or alpha-numeric string of text. This sensitive data needs to be recognized and secured. The system 100 allows for the identification of this type of data so that it can be secured.

### Methods of Operation

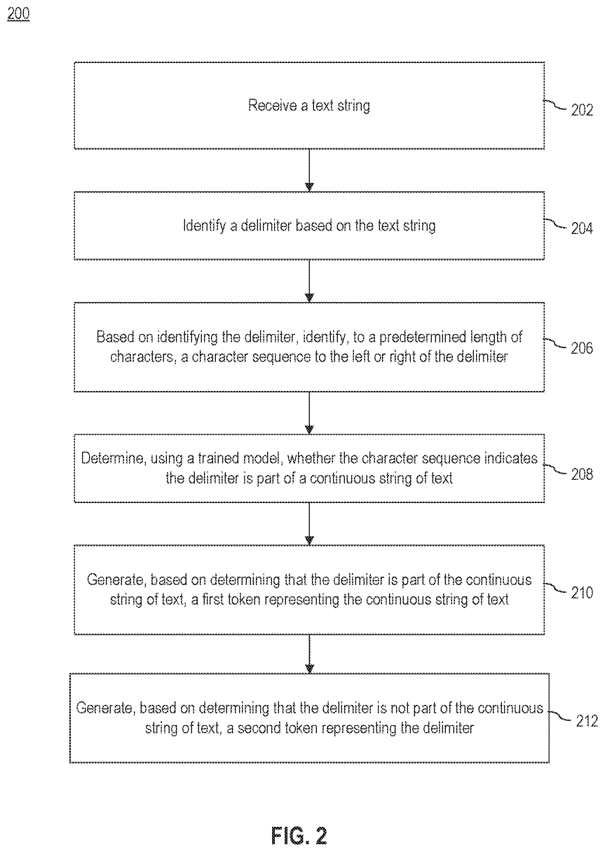

FIG. 2 is an example method 200 of operating the system 100 to identify a delimiter 118 and generate a token 122 based on identifying a character sequence 120 to the left or right of the delimiter 118 according to aspects of the present disclosure. Method 200 may be performed as a series of steps by a computing unit such as a processor. At step 202, the system 100 can receive a text string. At step 204, the system 100 can identify a delimiter based on the text string. At step 206, based on identifying the delimiter, the system 100 can identify, to a predetermined length of characters, a character sequence to the left or right of the delimiter. At step 208, using a trained model, the system 100 can determine whether the character sequence indicates the delimiter is part of a continuous string of text. At step 210, a first token representing the continuous string of text can be generated if the delimiter is determined to be part of the continuous string of text. At step 212 a second token can be generated representing the delimiter if the delimiter is determined to not be part of the continuous string of text.

The operation of method 200 is performed, for example, by system 100, in accordance with aspects described above.

### Components of the System

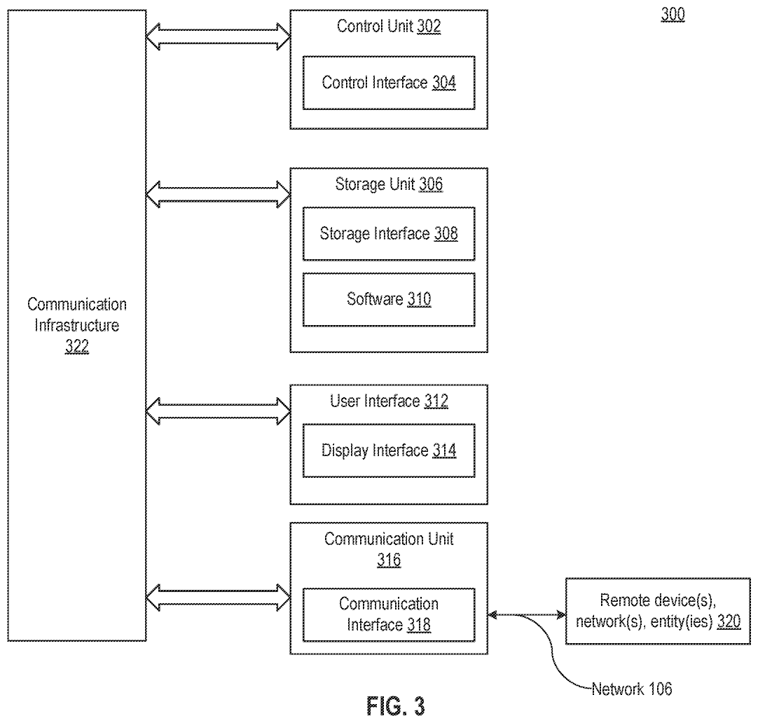

FIG. 3 is an example architecture 300, of devices that can be used to implement the system 100 according to aspects of the present disclosure. The architecture 300 can comprise various components. The components may be the components of the server 104 or the client device 102. In aspects, the components may include a control unit 302, a storage unit 306, a communication unit 316, and a user interface 312. The control unit 302 may include a control interface 304. The control unit 302 may execute a software 310 to provide some or all of the intelligence of system 100. The control unit 302 may be implemented in a number of different ways. For example, the control unit 302 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 304 may be used for communication between the control unit 302 and other functional units or devices of system 100. The control interface 304 may also be used for communication that is external to the functional units or devices of system 100. The control interface 304 may receive information from the functional units or devices of system 100, or from remote devices 320, such a client device 102, or may transmit information to the functional units or devices of system 100, or to remote devices 320. The remote devices 320 refer to units or devices external to system 100.

The control interface 304 may be implemented in different ways and may include different implementations depending on which functional units or devices of system 100 or remote devices 320 are being interfaced with the control unit 302. For example, the control interface 304 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 304 may be connected to a communication infrastructure 322, such as a bus, to interface with the functional units or devices of system 100 or remote devices 320.

The storage unit 306 may store the software 310. For illustrative purposes, the storage unit 306 is shown as a single element, although it is understood that the storage unit 306 may be a distribution of storage elements. Also for illustrative purposes, the storage unit 306 is shown as a single hierarchy storage system, although it is understood that the storage unit 306 may be in a different configuration. For example, the storage unit 306 may be formed with different storage technologies forming a memory hierarchical system including different levels of caching, main memory, rotating media, or off-line storage. The storage unit 306 may be a volatile memory, a nonvolatile memory, an internal memory, an external memory, or a combination thereof. For example, the storage unit 306 may be a nonvolatile storage such as nonvolatile random access memory (NVRAM), Flash memory, disk storage, or a volatile storage such as static random access memory (SRAM) or dynamic random access memory (DRAM).

The storage unit 306 may include a storage interface 308. The storage interface 308 may be used for communication between the storage unit 306 and other functional units or devices of system 100. The storage interface 308 may also be used for communication that is external to system 100. The storage interface 308 may receive information from the other functional units or devices of system 100 or from remote devices 320, or may transmit information to the other functional units or devices of system 100 or to remote devices 320. The storage interface 308 may include different implementations depending on which functional units or devices of system 100 or remote devices 320 are being interfaced with the storage unit 306. The storage interface 308 may be implemented with technologies and techniques similar to the implementation of the control interface 304.

The communication unit 316 may enable communication to devices, components, modules, or units of system 100 or to remote devices 320. For example, the communication unit 316 may permit the system 100 to communicate between the server 104 and the client device 102. The communication unit 316 may further permit the devices of system 100 to communicate with remote devices 320 such as an attachment, a peripheral device, or a combination thereof through the network 106.

As previously indicated with respect to FIG. 1, the network 106 may span and represent a variety of networks and network topologies. For example, the network 106 may be a part of a network that includes wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 may traverse a number of network topologies and distances. For example, the network 106 may include direct connection, personal area network (PAN), local area network (LAN), metropolitan area network (MAN), wide area network (WAN), or a combination thereof.

The communication unit 316 may also function as a communication hub allowing system 100 to function as part of the network 106 and not be limited to be an end point or terminal unit to the network 106. The communication unit 316 may include active and passive components, such as microelectronics or an antenna, for interaction with the network 106.

The communication unit 316 may include a communication interface 318. The communication interface 318 may be used for communication between the communication unit 316 and other functional units or devices of system 100 or to remote devices 320. The communication interface 318 may receive information from the other functional units or devices of system 100, or from remote devices 320, or may transmit information to the other functional units or devices of the system 100 or to remote devices 320. The communication interface 318 may include different implementations depending on which functional units or devices are being interfaced with the communication unit 316. The communication interface 318 may be implemented with technologies and techniques similar to the implementation of the control interface 304.

The user interface 312 may present information generated by system 100. In aspects, the user interface 312 allows the users to interface with the system 100. The user interface 312 can allow users of the system 100 to interact with the system 100. The user interface 312 may include an input device and an output device. Examples of the input device of the user interface 312 may include a keypad, buttons, switches, touchpads, soft-keys, a keyboard, a mouse, or any combination thereof to provide data and communication inputs. Examples of the output device may include a display interface 314. The control unit 302 may operate the user interface 312 to present information generated by system 100. The control unit 302 may also execute the software 310 to present information generated by system 100, or to control other functional units of system 100. The display interface 314 may be any graphical user interface such as a display, a projector, a video screen, or any combination thereof.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 200 and system 100 is cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computer implemented method for partitioning text, the method comprising:
receiving, by one or more computing devices, a text string;
identifying, by the one or more computing devices, a delimiter based on the text string;
based on identifying the delimiter, identifying, by the one or more computing devices and to a predetermined length of characters, a character sequence to the left or right of the delimiter;
determining, by the one or more computing devices and using a trained model, whether the character sequence indicates the delimiter is part of a continuous string of text; and
generating, by the one or more computing devices and based on determining that the delimiter is part of the continuous string of text, a first token representing the continuous string of text; and
generating, by the one or more computing devices and based on determining that the delimiter is not part of the continuous string of text, a second token representing the delimiter.

2. The method of claim 1, further comprising receiving, by the one or more computing devices, the text string in real-time based on inputs entered into a client device.

3. The method of claim 1, further comprising:
receiving, by the one or more computing devices, a document; and
wherein the text string is embedded in the document.

4. The method of claim 1, wherein the trained model is a character-level sequence-to-sequence model.

5. The method of claim 4, wherein the trained model is a long short term memory (LSTM) model.

6. The method of claim 4, wherein the trained model is a recurrent neural network (RNN) model.

7. The method of claim 1, wherein the delimiters comprise: a dash, a semicolon, an underscore, a comma, or a period.

8. A non-transitory computer readable medium including instructions for partitioning text that when executed by a processor perform the operations comprising:
receiving, by one or more computing devices, a text string;
identifying, by the one or more computing devices, a delimiter based on the text string;
based on identifying the delimiter, identifying, by the one or more computing devices and to a predetermined length of characters, a character sequence to the left or right of the delimiter;
determining, by the one or more computing devices and using a trained model, whether the character sequence indicates the delimiter is part of a continuous string of text; and
generating, by the one or more computing devices and based on determining that the delimiter is part of the continuous string of text, a first token representing the continuous string of text; and
generating, by the one or more computing devices and based on determining that the delimiter is not part of the continuous string of text, a second token representing the delimiter.

9. The non-transitory computer readable medium of claim 8, wherein the operations further comprise receiving, by the one or more computing devices, the text string in real-time based on inputs entered into a client device.

10. The non-transitory computer readable medium of claim 8, wherein the operations further comprise:
receiving, by the one or more computing devices, a document; and
wherein the text string is embedded in the document.

11. The non-transitory computer readable medium of claim 8, wherein the trained model is a character-level sequence-to-sequence model.

12. The method of claim 11, wherein the trained model is a long short term memory (LSTM) model.

13. The method of claim 11, wherein the trained model is a recurrent neural network (RNN) model.

14. The non-transitory computer readable medium of claim 8, wherein the delimiters comprise:
a dash, a semicolon, an underscore, a comma, or a period.

15. A computing system for partitioning text comprising:
a communications unit configured to receive a text string;
a control unit, coupled to the communications unit, configured to:
identify a delimiter based on the text string;
based on identifying the delimiter, identify, to a predetermined length of characters, a character sequence to the left or right of the delimiter;
determine, using a trained model, whether the character sequence indicates the delimiter is part of a continuous string of text; and
generate, based on determining that the delimiter is part of the continuous string of text, a first token representing the continuous string of text; and
generate, based on determining that the delimiter is not part of the continuous string of text, a second token representing the delimiter.

16. The computing system of claim 15, wherein the communications unit is further configured to receive the text string in real-time based on inputs entered into a client device.

17. The computing system of claim 15, wherein the trained model is a character-level sequence-to-sequence model.

18. The computing system of claim 17, wherein the trained model is a long short term memory (LSTM) model.

19. The computing system of claim 17, wherein the trained model is a recurrent neural network (RNN) model.

20. The computing system of claim 15, wherein the delimiters comprise: a dash, a semicolon, an underscore, a comma, or a period.
